(19) United States
(12) Patent Application Publication
(10) Pub. No.: US 2010/0065186 A1
(43) Pub. Date: Mar. 18, 2010

(54) METHOD AND APPARATUS FOR PRODUCING A MORE REALISTIC WOOD GRAIN ON A SURFACE OF WOOD

(76) Inventors: Surya Kurniawan, Jakarta Selatan (ID); Slamet Kurniawan, Jakarta Utara (ID)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/517,480

(22) PCT Filed: Dec. 20, 2006
(86) PCT No.: PCT/ID2006/000007

§ 371 Date: Jun. 3, 2009

(51) Int. Cl. B32B 37/00; B32B 38/00

(52) U.S. Cl. 156/61; 156/384

(57) ABSTRACT

This invention provides a method for producing wooden board having wood grain printed on its flat surface and on the surface of its side parts, i.e., on its cross-sectional surface, consisting of the preparation, printing and finishing stages. This invention also provides apparatus used for printing natural grain of wood on any flat surfaces and on the surface of the cross-sectional parts of a wooden board.

### TECHNICAL FIELD OF THE INVENTION

This invention relates to a method for producing surfaces that have more realistic nature of wood grain frequently used in furniture business, particularly to a method for producing wood grain on a surface by way of printing, and also an apparatus used for implementing such method. The term ‘print’ in this description is used for describing ‘printing’ method.

### BACKGROUND OF THE INVENTION

Furniture production is currently experiencing an extremely difficult problem in obtaining wood from forests. Therefore, nowadays most furniture is made of processed juvenile wood, or light wood for making pieces of furniture.

Processed woods are then converted into wooden boards generally doesn't have any grain on their entire surface. Therefore, such wood grain is produced by either sticking “veneer” coat on the wood surface or producing it separately by printing it on a piece of certain material, and then sticking it on the wood surface in order to give the appearance of wood grain. Such sticking may not last long because it very much depends on the glue used and the condition where such piece of furniture is kept, such as in humid or dry condition that may shorten the sticking power. Another weakness of this kind of product is the absence of appearance and impression of natural wood on the wood surface used.

In addition, there is also the use of the so-called ‘printing’ method on the board surface in this description. Printing on surface having been given the sealer can use a variety of colors adjusted to the intended motive/texture of the wood. The printing is made on flat surface only, instead of on the cross-section part of the wooden board. The cross-section part of the board is very difficult place to print on, and even if it is possible, it requires very expensive equipment, so that the production cost will be high.

For this purpose, this invention provides method and equipment for printing on the cross-section area of any processed-wood boards that will solve above-mentioned problem.

### BRIEF SUMMARY OF THE INVENTION

It is the primary purpose of this invention to provide a method for producing wood grain on the flat surface of any processed-wood boards.

The other purpose of this invention is to provide method for producing wood grain on the surface of any cross-sectional part of the wood.

Furthermore, this invention also provides method for printing natural grain of wood on the flat surface of any woods, as well as on their cross-sectional part.

This invention also provides equipment for printing natural grain of wood on flat surface, as well as on the cross-sectional surface of any wooden board.

### BRIEF DESCRIPTION OF THE DRAWING

Furthermore, in order to explain the scope of this invention, an example is given in form of drawings in the description, and it is not for narrowing the scope of the invention, in which:

FIG. 1 is the steps taken in the method of producing wood grain according to this invention.

### DETAILED DESCRIPTION OF THE INVENTION

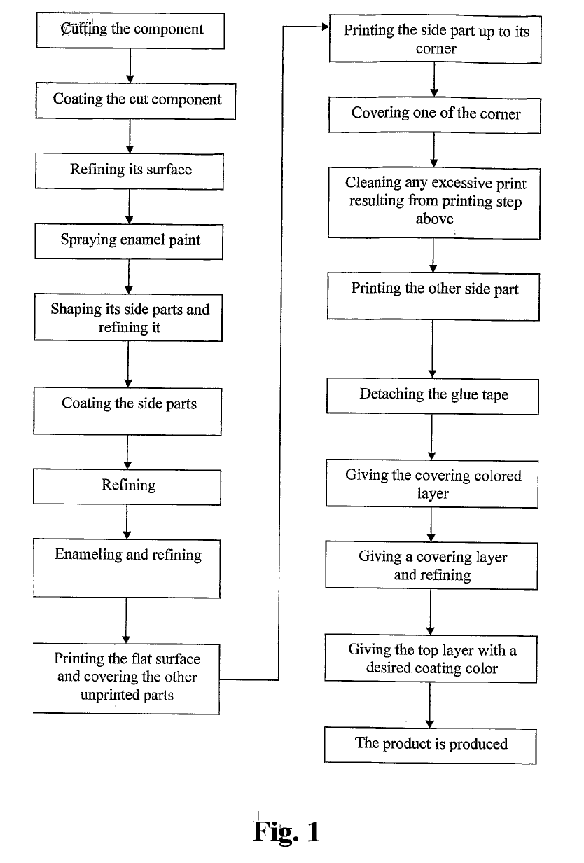

Furthermore, this invention will be explained by looking at FIG. 1, attached to this description.

Before explaining the steps and equipment used in this invention, it is necessary to explain about the terms used so that it will give the same understanding as the inventor does.

Component herein may be in form of wooden board, processed-wood board, MDF, or their kinds usually used as components in knocked-down furniture industry. Pore-covering coat used is the one known as UV sanding sealer. The use of enamel paint for both hardening and strengthening the component's surface is made before printing. The so-called side part is the surface part of the cross section of any component. Glue used for covering a corner of the side part is of cellulose tape, isolation tape or other similar types that can be used for covering certain part so that it will not be printed, and the glue will be detached after the process is completed. These kinds of glue are preferred because they can be used repeatedly. The term ‘to print’, ‘printed’, and ‘printing’ are also used.

The outline of printing component surface consists of the following steps:

1. Preparation step that consists of:
a. Cutting the component according to the desired size;
b. Coating the component, that has been cut, with a pore-covering layer;
c. Refining the surface of component having been coated;
d. Spraying enamel paint;
e. Giving shape to the side part, i.e., the cross-sectional part, into the desired shape, such as, spherical, rectangular, contoured, etc. and refining it;
f. Repeat steps 1.b and 1.c for the side part;
g. Especially for the side part, the enamel paint is sprayed and any parts that will not be printed should be covered, if necessary.
   2. Printing step that consists of:
a. Printing the flat surface with the contour of wood grain desired and covering the other unprinted parts so that they remain clean;
b. Covering the flat surface having been printed by using sanding sealer in order to protect it when processing the next stage;
c. Printing the side part up to its corner;
d. Covering one of the corners with glue tape according to the connection shape desired;
e. Cleaning any remaining result of printing of step c above;
f. Printing the other side parts up to their corner that have been covered with glue tape;
g. Detaching the glue tape on such corners;
   3. Finishing step that consists of:
a. Covering the pores with pore-covering layers by way of spraying;
b. Refining all surfaces; and
c. Coating the surfaces with the desired coating color and/or making them transparent.

Such coloring, if necessary, may be done at the time of covering the pores or at the time of spraying enamel paint by mixing the desired color with the material used.

Furthermore, the detailed method according to this invention covers the following steps:

1. Preparation step that consists of:
a. Cutting the material according to the desired size;
b. Coating the pores on the flat surface of the upper and lower parts in order to protect the fine surface.
c. After the pore-covering layers are completely dry, refine the surface where the wood grain will be printed;
d. Spraying enamel paint on such surfaces;
e. Refining them after they are completely dry;
f. Reshaping the side parts, i.e., the surface of the cross section part into the desired shape;
g. Refining such side parts;
h. Covering the pores on the side parts of the component;
i. Refining the side parts of the component, if necessary. This process may be repeated if the pores haven't been fully covered or if the fine surface haven't been obtained;
j. Covering any surfaces that will not be printed by using paper (preferred). It is meant to keep such surfaces clean during the next process;
k. Spraying enamel paint to the side parts of the component;
l. Refining the side parts having been painted with enamel;
m. Cleaning them from any dusts produced in the previous steps.
   2. Printing step that consists of:
a. Printing the flat surface with the contour of wood grain desired;
b. Covering the flat surface having been printed by using sanding sealer in order to protect it when processing the next stage;
c. Printing the side part with different contour of wood grain from the one on the flat surface, on the two opposite sides of that part, in this case, there are 2 corners;
   Covering one of the corners of the cross-sectional part with glue having been shaped into certain connection shape (for instance, protruding or notch shape or others). Any excessive print should be cleaned using thinner;
e. Printing the corners having been covered (with glue tape) with desired pattern of wood grain;
   3. Finishing step that consists of:
a. Detaching the glue tape on the corner, after such corner is completely dry, having been printed so that the pattern of wood grain desired can be seen;
b. Giving the covering layer by way of spraying;
c. Refining all surfaces after the covering layers are completely dry;
d. Giving the top layer with the desired coating color and/or making them transparent;
e. Component having natural grain of wood on its surface has been produced.

To implement the steps given in the description above, it is necessary to have suitable equipment for this invention, which is different from the previous invention. The equipment is a printing machine that consists of two closely neighboring rolls, in which the first roll is in form of metal roll having notches constituting the picture of grain pattern of wood to be printed, and the second roll is a rubber roll that will print such pattern on the surface of the component to be printed. The notch on the first roll is filled with printing ink, and because the two rolls are close to each others, the ink on the first roll will move to the surface of the second roll. It is the second roll that will touch the surface of the component to be printed.

To print the side parts of the component, the two rolls are used in the above manner, but they are made at an angle that can be arranged in order to reach the entire surface, including the corners. The angle can be arranged manually or automatically. Printing on the side parts is made one by one for each surface up to the corner. The glue tape mentioned above is shaped according to the desired connection. Printing on the other side surfaces is made in order to form certain connection print.

To make it clear, the printing on surface in this invention is made in integration between the flat surface and the side surfaces.

In witness whereof, this invention has been revealed by using drawings attached to this description. However, the drawings with their number is not meant to limit the scope of the invention, but, instead, it is meant to make the invention easier to understand, because it is believed that it will be easy for any experts in this sector to make changes, modification or variation to the aforementioned description without having to go beyond this scope of this invention, so that the demanded protection will be revealed in the following claims.

1. A method for printing surfaces of wooden components with natural grain of wood that consists of the following steps:
a. Preparation step that consists of:
Cutting the component according to the desired size;
Coating the component, that has been cut, with a pore-covering layer;
Refining the surface of component having been coated;
Spraying enamel paint;
Giving shape to the side parts, i.e., the cross-sectional part, into the desired shape, such as, spherical, rectangular, contoured, etc. and refining it
Repeating steps 1.b and 1.c for the side part;
Especially for the side part, the enamel paint is sprayed and any parts that will not be printed should be covered;
b. Printing step that consists of:
Printing the flat surface with the contour of wood grain desired and covering the other unprinted surfaces so that they remain clean;
Covering the flat surface having been printed by using sanding sealer in order to protect it when processing the next stage;
Printing the side part up to its corner;
Covering one of the corners with glue tape according to the connection shape desired;
Cleaning any excessive print resulting from printing step above;
Printing the other side parts up to their corner that have been covered with glue tape;
Detaching the glue tape on such corners.
c. Finishing step that consists of:
Covering the pores with pore-covering layers by way of spraying;
Refining all surfaces; and
Coating the surfaces with the desired coating color and/or making them transparent.

2. The method for printing surface pursuant to claim 1 above is characterized by the fact that the second paint layer used is enamel paint capable of hardening and strengthening the surfaces of components to be printed.

3. The method for printing surface pursuant to claim 1 above is characterized by the fact that when printing the side parts, the next steps can be taken, i.e., by covering one part of the corner of the cross-sectional part with glue having been shaped into certain connection shape and then to print the corner having been covered (with glue tape) with desired pattern of wood grain.

4. Apparatus used for printing the surfaces of wooden components with natural grain of wood is used for printing the side part of the component that consists of two rolls that are placed at an angle and such angle can be arranged in order to reach the entire surface, including the corner part.

5. Apparatus used for printing pursuant to claim 4 is characterized by the fact that in order to make impression about the presence of natural connection, the corner can be divided into two parts from the component's side and the glue tape having been given the shape of connection on at least one of its end.
